(19) United States
(12) Patent Application Publication
(10) Pub. No.: US 2019/0301928 A1
(43) Pub. Date: Oct. 3, 2019

(54) DISPLAY DEVICE

(71) Applicant: SHARP KABUSHIKI KAISHA, Osaka (JP)

(72) Inventor: HIROMI ENOMOTO, Sakai City (JP)

(21) Appl. No.: 16/368,819

(22) Filed: Mar. 28, 2019

Related U.S. Application Data
(60) Provisional application No. 62/649,789, filed on Mar. 29, 2018.

(51) Int. Cl. G01J 1/50; G01J 1/42; G02F 1/1333

(52) U.S. Cl. CPC G01J 1/50; G02F 1/1333; G01J 1/429

(57) ABSTRACT

A display includes a display component having a display surface displaying an image thereon and an ultraviolet ray detection section included in a section of the display component that is to be irradiated with external light, and the ultraviolet ray detection section contains material that changes its color by irradiation of ultraviolet rays.

### CROSS REFERENCE TO RELATED APPLICATION

This application claims priority from U.S. Provisional Application No. 62/649,789 filed on Mar. 29, 2018. The entire contents of the priority application are incorporated herein by reference.

### TECHNICAL FIELD

The present technology described herein relates to a display device.

### BACKGROUND ART

A display device including an ultraviolet sensor that can detect ultraviolet rays has been known and a watch including an ultraviolet sensor is used as the display device. The ultraviolet sensor outputs analog signals according to an amount of supplied ultraviolet rays and a detection result of the ultraviolet sensor is displayed on a display section included in a liquid crystal panel.

The above configuration is required to include the ultraviolet sensor that outputs analog signals according to an amount of ultraviolet rays and the display section that displays the amount of ultraviolet rays, and the configuration for detecting the ultraviolet rays is complicated.

### SUMMARY

The present technology described herein is achieved in view of the above circumstances, and an object is to provide a display device that can detect ultraviolet rays with a simpler configuration.

To solve the above problems, a display device of the present invention includes a display component having a display surface displaying an image thereon and an ultraviolet ray detection section included in a section of the display component, the section being to be irradiated with external light, and the ultraviolet ray detection section contains material that changes its color by irradiation of ultraviolet rays. If the ultraviolet ray detection section is exposed to the external light sand the color of the ultraviolet ray detection section is changed by the ultraviolet rays included in the external light. Accordingly, presence of ultraviolet rays can be visually recognized. According to the configuration of detecting ultraviolet rays by using the material that changes its color by the ultraviolet rays, the ultraviolet rays can be detected with a simpler configuration compared to a configuration of outputting an electric signal according to the amount of ultraviolet rays and displaying the amount of ultraviolet rays based on the electric signal.

According to the present technology described herein, a display device that can detect ultraviolet rays with a simpler configuration can be provided.

### BRIEF DESCRIPTION OF THE DRAWINGS

FIG. 1 is a plan view of a liquid crystal display device according to a first embodiment of the present technology.

FIG. 2 is a cross-sectional view of the liquid crystal display device (corresponding to a drawing taken along line II-II in FIG. 1).

FIG. 3 is a plan view illustrating the liquid crystal display device that is irradiated with ultraviolet rays.

FIG. 4 is a plan view illustrating a liquid crystal display device that is irradiated with ultraviolet rays according to a second embodiment.

FIG. 5 is a cross-sectional view of a liquid crystal display device according to a third embodiment.

### DETAILED DESCRIPTION

### First Embodiment

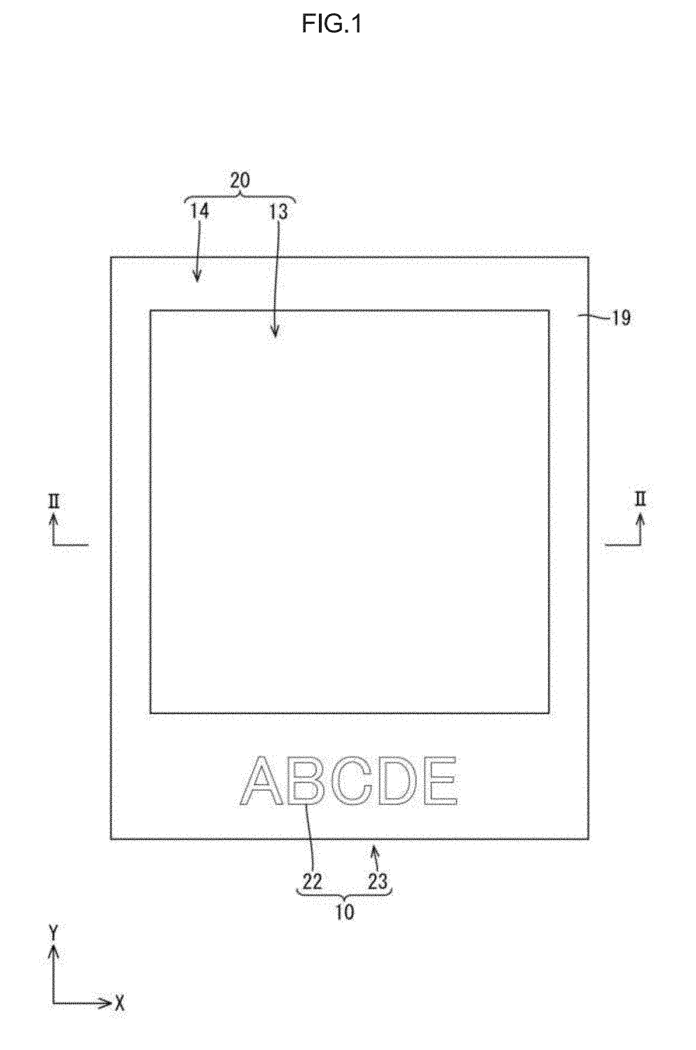

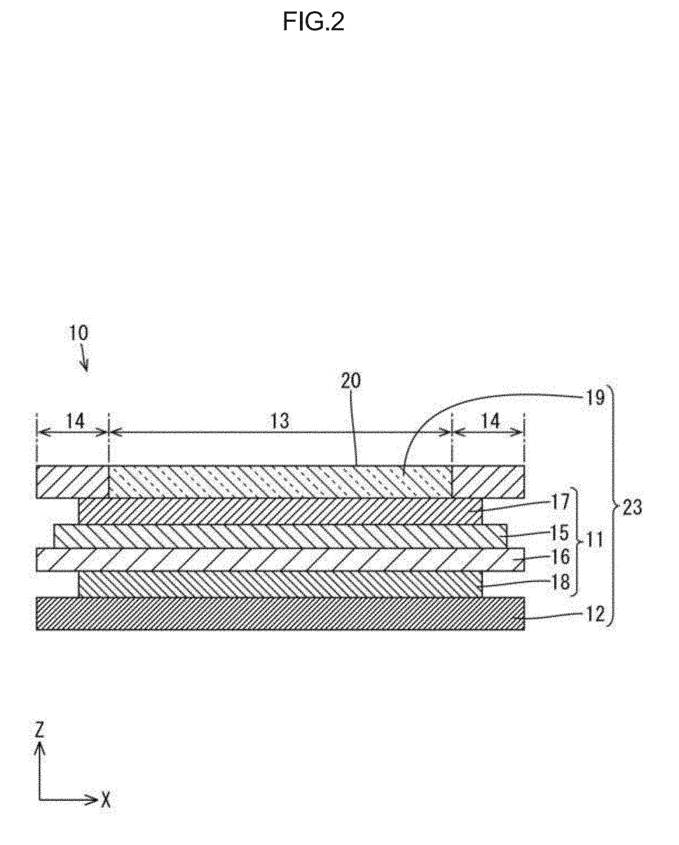

A first embodiment of the present technology will be described with reference to FIGS. 1 to 3. As illustrated in FIG. 1, a liquid crystal display device 10 includes a display component 23 and characters 22 printed on a cover panel 19 included in the display component 23. As illustrated in FIG. 2, the display component 23 includes a backlight unit 12, a liquid crystal panel 11 (a display panel), and the cover panel 19. The liquid crystal display device 10 may be used in various kinds of electronic devices such as wearable terminals (including smart watches), mobile phones (including smartphones), notebook computers (including tablet computers), handheld terminals (including electronic books and PDAs), and portable video game players.

The liquid crystal panel 11 has a quadrangular shape and includes a pair of substrates 15, 16 that are opposite each other, a liquid crystal layer that is between the substrates 15, 16 and contains liquid crystal molecules as a substance that changes its optical characteristics according to application of electric field, and polarizing plates 17, 18, as illustrated in FIG. 2. One of the pair of substrates 15, 16 on the front (on an upper side in FIG. 1) is a CF substrate 15 and another one on the rear is an array substrate 16 (an active matrix substrate). The CF substrate 15 includes a glass substrate and color filters that are stacked on an inner surface side of the glass substrate.

The array substrate 16 includes various kinds of films that are disposed on the inner surface side of a glass substrate with the photolithography method. The array substrate 16 includes switching components such as TFTs and pixel electrodes. The polarizing plates 17, 18 are bonded to outer surfaces of the substrates 15, 16, respectively. The backlight unit 12 includes LEDs and a light guide plate and is configured to supply light to the liquid crystal panel 11. According to such a configuration, the liquid crystal panel 11 displays an image with using light from the backlight unit 12.

The cover panel 19 is arranged to cover the CF substrate 15 (a substrate) and the polarizing plate 17. A surface of the cover panel 19 is a display surface 20 of the display component 23. The display surface 20 is a surface on which an image is displayed. The cover panel 19 is made of material having light transmissivity and is a quadrangular plate. Material of the cover panel 19 may be glass or synthetic resin (for example, acrylic resin such as PMMA). Light blocking material that blocks light (such as black paint) is disposed on an outer peripheral edge section of the cover panel 19. An outer peripheral edge section of the display surface 20 is a non-display area 14 where no image is displayed. An inner area of the display surface 20 surrounded by the non-display area 14 is a display area 13. The backlight unit 12 is disposed to overlap at least the display area 13 with respect to the Z-axis direction (an upper-lower direction in FIG. 2) and is configured such that light from the backlight unit 12 travels toward the display area 13. A touch sensor may be provided on the cover panel 19.

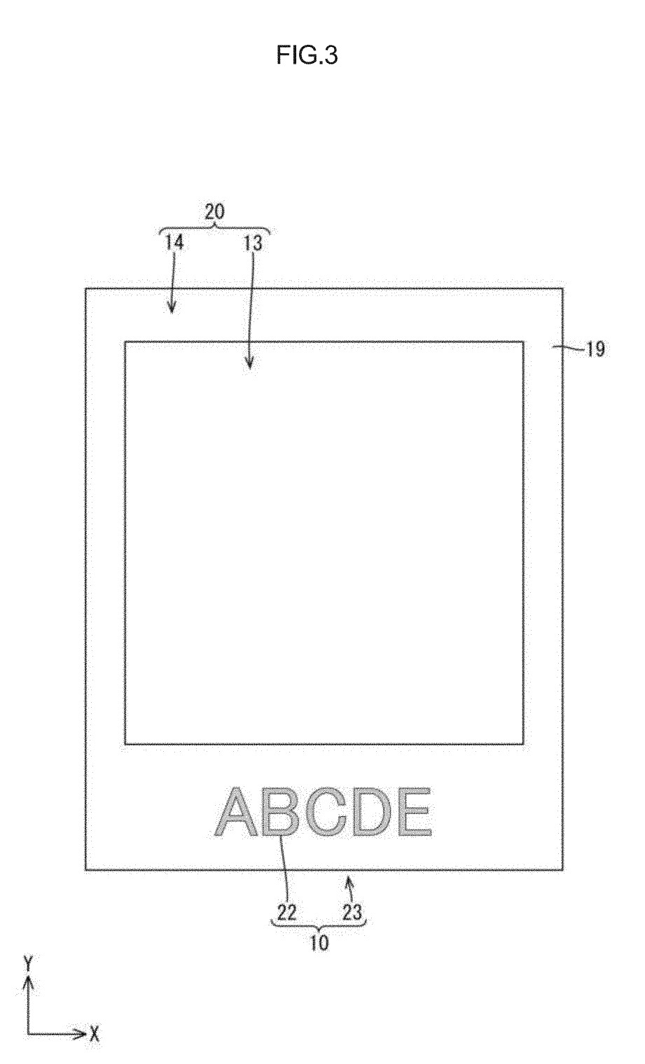

As illustrated in FIG. 1, the characters 22 are printed in one of four side sections of the non-display area 14 (a frame-shaped area) having a quadrangular frame shape. The characters 22 include, for example, a phrase notifying presence of ultraviolet rays or a logo mark related to the liquid crystal display device 10. However, the characters 22 are not limited thereto. Ink for the characters 22 contains a photochromic compound. The photochromic compound has characteristics of changing its color upon exposure to ultraviolet rays. Such photochromic compounds include compounds of azobenzenes, diarylethenes, spiropyrans, and fulgides, for example. Accordingly, as illustrated in FIG. 3, if the character 22 is exposed to external light, a color of the character 22 is changed by the ultraviolet rays included in the external light rays. Namely, the characters 22 are an ultraviolet ray detection section provided on the display surface 20 that is irradiated with the external light rays. Change of a color here includes color change from colorless to any color (coloring).

The photochromic compounds have reversibility and in the present embodiment, it is preferable to use photochromic compounds that return to a state before color changing according to exposure to visible light. Accordingly, for example, if the color of the character 22 is changed by the ultraviolet rays under the external light and after that a condition is changed to have less influence of the ultraviolet rays, the character 22 returns to the state before the color changing by the visible light. Examples of such photochromic compounds include compounds of azobenzenes and diarylethenes. Especially, the compounds of azobenzenes and diarylethenes turn to be colorless according to irradiation with visible light and therefore, the original color of the character 22 is less likely to be influenced by the color of the photochromic compounds. Such compounds are preferable. For example, the diarylethene compound exhibits red by a ring-closing reaction with ultraviolet rays and loses the color by a ring-opening reaction with visible light. Therefore, if the intensity of ultraviolet rays included in sunlight is increased under the external light, the ring-closing reaction has higher priority to the ring-opening reaction and the compound is in a coloring state.

Next, advantageous effects of the present embodiment will be described. In the present embodiment, the characters 22, which are the ultraviolet ray detection section, are exposed to the external light and the color of the characters 22 is changed by the ultraviolet rays included in the external light. Accordingly, a user can visually know presence of ultraviolet rays. According to the configuration of detecting ultraviolet rays by using the photochromic compound that changes its color by the ultraviolet rays, the ultraviolet rays can be detected with a simpler configuration compared to a configuration of outputting an electric signal according to the amount of ultraviolet rays and displaying the amount of ultraviolet rays based on the electric signal.

In the present embodiment, the characters 22, which are the ultraviolet ray detection section, are arranged on the display surface 20. The characters 22 that are arranged on the display surface 20 can receive the external light surely and a user can easily recognize the color change caused by the ultraviolet rays.

In the present embodiment, the display surface 20 includes the display area 13 where an image is displayed and the non-display area 14 disposed around the display area 13, and the characters 22, which are the ultraviolet ray detection section, are arranged on the non-display area 14. The ultraviolet ray detection section is arranged on the non-display area and therefore, even if the color of the ultraviolet ray detection section is changed by the ultraviolet rays, the color is less likely to influence an image displayed on the display area.

The photochromic compound included in the characters 22 turns to be colorless by irradiation with the visible light. Accordingly, if a liquid crystal display device 210 is moved to an environment with less influence of the ultraviolet rays (such as inside a room) after the color of the characters 22 is changed in an environment with great influence of ultraviolet rays (such as outside of a room), the influence of the visible light is relatively greater than the influence of the ultraviolet rays and the characters 22 returns to the state before the color change. Therefore, a process for returning the characters 22 to the state before the color change is not necessary to be performed and it is preferable. A photochromic compound that returns to a state before the color change by application of heat may be used. However, a photochromic compound that returns to the state before the color change by irradiation of visible light is more preferable due to the above reasons.

### Second Embodiment

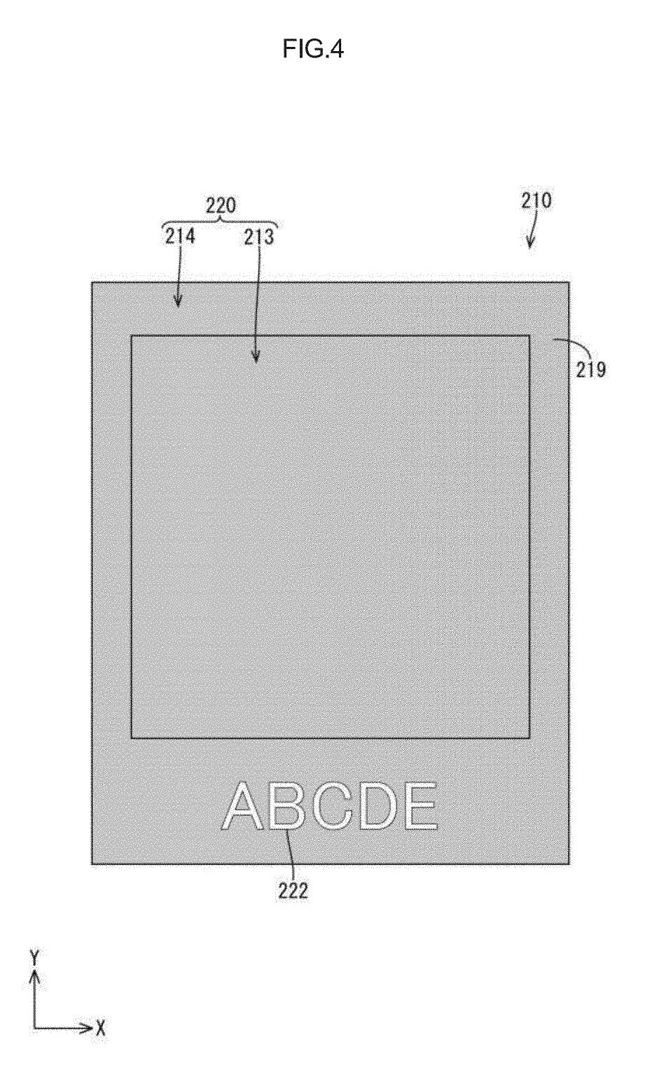

Next, a second embodiment will be described with reference to FIG. 4. Components same as those of the above embodiment are provided with the same symbols and will not be described. A liquid crystal display device 210 according to the present embodiment differs from the above embodiment in a configuration of a cover panel. A cover panel 219 according to the present embodiment contains a photochromic compound. Namely, the cover panel 219 includes the ultraviolet ray detection section. Accordingly, as illustrated in FIG. 4, if the cover panel 219 is irradiated with ultraviolet rays, the color of an entire area of the cover panel 219 is changed. Accordingly, a user can visually recognize the presence of the ultraviolet rays. Since the cover panel 219 contains the photochromic compound as is in the present embodiment, the ultraviolet ray detection section is easily provided on the cover panel 219.

In the present embodiment, the color of the entire area of a display surface 220 of the cover panel 219 is changed. However, it is not limited thereto. For example, the cover panel 219 may not contain the photochromic compound in a section corresponding to the display area 213 and may contain the photochromic compound only in a section corresponding to the non-display area 214. Further, in the present embodiment, characters 222 printed in the non-display area 214 do not contain the photochromic compound. Accordingly, upon the irradiation with ultraviolet rays, the color of the non-display area 214 is changed and the color of the characters 222 is not changed. Therefore, the characters 222 can be easily recognized and visibility and design of the characters 222 can be ensured.

### Third Embodiment

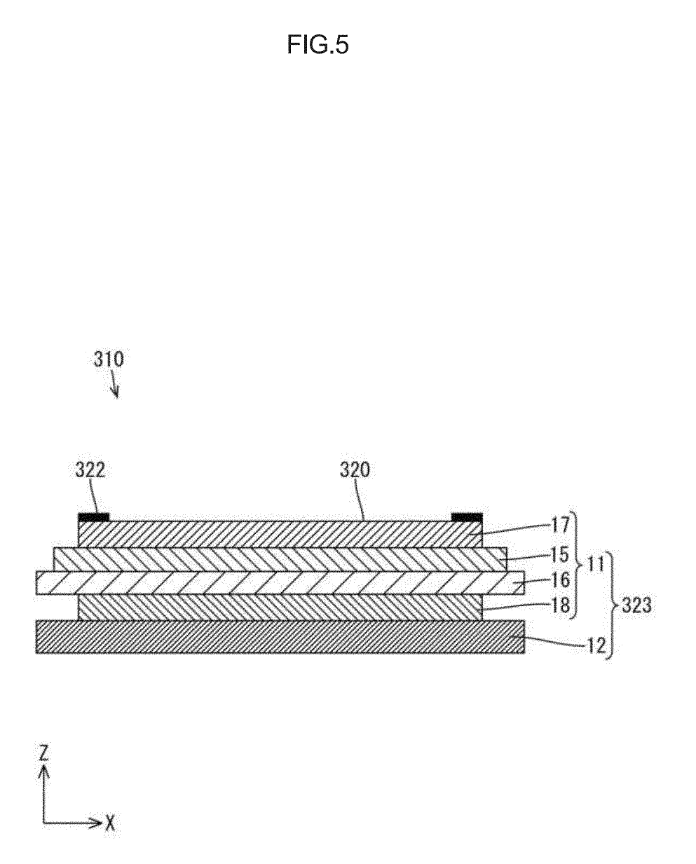

Next, a third embodiment of the present invention will be described with reference to FIG. 5. Components same as those of the above embodiments are provided with the same symbols and will not be described. As illustrated in FIG. 5, a liquid crystal display device 310 of the present embodiment includes a display component 323 and an ultraviolet ray detection section 322. The display component 323 includes the liquid crystal panel 11 and the backlight unit 12. Namely, the present embodiment does not include a cover panel and a surface of the polarizing plate 17 is a display surface 320 of the display component 323. The ultraviolet ray detection section 322 is arranged on the outer peripheral edge section (the non-display area) of the polarizing plate 17. The ultraviolet ray detection section 322 is formed by printing ink containing the photochromic compound.

### OTHER EMBODIMENTS

The present technology described herein is not limited to the embodiments described in the above and the drawings but the following embodiments may be included in the scope of the technology according to the present invention.

(1) In the above embodiments, the ultraviolet ray detection section is included in the liquid crystal panel. However, the configuration is not limited thereto. The ultraviolet ray detection section is necessarily provided on a section of the cover panel, the liquid crystal panel, and the backlight unit that is irradiated with external light and, for example, may be arranged on an outer surface of the backlight unit 12.

(2) In the above embodiments, the ultraviolet ray detection section is arranged on the display surface of the display component. However, the configuration is not limited thereto. In a configuration that each of the components included in the display component (for example, a tape covering a driver that drives the liquid crystal panel, a cable such as FPC, and a substrate) is irradiated with external light, the ultraviolet ray detection section may be arranged on such a component.

(3) In the above embodiments, the photochromic compounds are used as the material that changes its color upon irradiation of the ultraviolet rays. However, the material is not limited thereto. For example, wavelength conversion material that absorbs ultraviolet rays and exits visible light may be used as the material that changes its color upon irradiation of the ultraviolet rays. If such wavelength conversion material is used, the ultraviolet rays are converted to the visible light and the color of the ultraviolet ray detection section is changed to the color of the visible light. Thus, the ultraviolet rays can be detected. Namely, the ultraviolet ray detection section necessarily has a property of changing its color before and after the irradiation of the ultraviolet rays.

(4) In the above embodiments, the liquid crystal panel and the backlight unit are used as the display component. However, it is not limited thereto. The display component may not include the backlight unit and examples of such a display component may be an organic EL panel and a plasma display panel.

(5) In the above embodiments, the characters 22 are used as the ultraviolet ray detection section. However, it is not limited thereto. For example, a symbol, a figure, or a pattern may be printed instead of the characters 22.

1. A display device comprising:
a display component having a display surface displaying an image thereon; and
an ultraviolet ray detection section included in a section of the display component, the section being to be irradiated with external light, the ultraviolet ray detection section containing material that changes its color by irradiation of ultraviolet rays.

2. The display device according to claim 1, wherein the ultraviolet ray detection section is arranged on the display surface.

3. The display device according to claim 1, wherein
the display surface includes a display area where an image is displayed and a non-display area that is around the display area, and
the ultraviolet ray detection section is arranged in the non-display area.

4. The display device according to claim 1, wherein
the display component includes a substrate and a cover panel covering the substrate and configures the display surface,
the ultraviolet ray detection section is arranged on the cover panel, and
the cover panel contains the material.

5. The display device according to claim 1, wherein the material turns to be colorless upon irradiation of visible light.
